(19) United States
(12) Patent Application Publication
(10) Pub. No.: US 2020/0324606 A1
(43) Pub. Date: Oct. 15, 2020

(54) LEVEL CONTROL SYSTEM AND METHOD FOR OPERATING A LEVEL ADJUSTMENT SYSTEM

(71) Applicant: SCHAEFFLER TECHNOLOGIES AG & CO. KG, Herzogenaurach (DE)

(72) Inventor: Christian HARKORT, Erlangen (DE)

(73) Assignee: SCHAEFFLER TECHNOLOGIES AG & CO. KG, Herzogenaurach (DE)

(21) Appl. No.: 16/306,423

(22) PCT Filed: May 3, 2017
(86) PCT No.: PCT/DE2017/100366

§ 371 Date: Nov. 30, 2018

(30) Foreign Application Priority Data
Jun. 2, 2016 (DE) 102016209685.0

(51) Int. Cl. B60G 17/018; B60G 17/015

(52) U.S. Cl. CPC B60G 17/0182; B60G 17/0157; B60G 2202/422; B60G 2800/70; B60G 2500/30

(57) ABSTRACT

A level adjustment system of a vehicle, comprising an electric engine a transmission driven by the electric engine; and a controller programmed to identify a motor current from the electric engine during an upward adjustment or downward adjustment of the vehicle, wherein the controller is further programmed to determine an actuator force generated by an actuator unit utilizing the motor current.

### CROSS-REFERENCE TO RELATED APPLICATIONS

This application is the U.S. National Phase of PCT/DE2017/100366 filed May 3, 2017, which claims priority to DE 102016209685.0 filed Jun. 2, 2016, the entire disclosures of which are incorporated by reference herein.

### TECHNICAL FIELD

The disclosure relates to a method for level adjustment, in particular level control, in a motor vehicle, and a device suitable for carrying out such a method.

### BACKGROUND

A method for leveling a motor vehicle is known, for example, from DE 10 2009 008 612 A1. The level adjustment is carried out here by means of an actuator with an electric engine, which has a rotatable engine element whose position is incrementally detected. The detected position of the engine element is transformed to an absolute height position of an actuator element. This known level control works with electromotive spindle drives.

A further level adjustment is known from DE 103 45 987 B4 for a motor vehicle, which operates with a spindle drive. In this connection, a spring plate in the axial direction of a spring-damper assembly is adjustable.

DE 38 26 843 C2 discloses a suspension system for motor vehicles, which is intended to enable a road-dependent level control. This system records the extent to which threshold values are achieved, related to jounce travel while driving.

Devices which are provided for determining weights in relationship to force of vehicles are known, for example, from DE 199 27 681 A1 and from DE 198 02 630 A1.

A level control, in particular with electromechanical actuators, makes it in general possible in a motor vehicle to raise and lower the vehicle body on one or more axes. The downward flow of the vehicle body can for example be carried out to reduce drag or to facilitate entry and exit and loading, while an increase of the vehicle body, for example to adapt to the road condition, becomes possible.

### SUMMARY

The disclosure may further develop a level adjustment, in particular a level control, of a motor vehicle compared to the cited prior art in terms of a particularly favorable ratio between inserted sensors and actuators on the one hand, and functional diversity and reliability on the other.

This object is achieved by a level adjustment system and by a method for operating a level adjustment system according to the disclosure below. Embodiments and advantages of the disclosure explained below in connection with the operating method, apply mutatis mutandis to the device, that is, the level adjustment system and vice versa. The level adjustment system can be designed as a level control system. The terms “level adjustment system” and “level control system” may be subsumed in short under the term “system”. Statements made with respect to the leveling adjustment system may continue to apply even in cases where this is a regulating system.

The level adjustment system may include an actuator unit, which may include an electric engine and a transmission driven by it, wherein a vehicle body is height-adjustable with the aid of the gearbox. For operation of the actuator unit, a control unit is provided, wherein an integrated calculation unit may detect in the control unit in cooperation with a current sensor is formed, for the computational determination of an actuator force generated by the actuator unit and introduced into components of the motor vehicle for adjusting its level.

As a result of this indirect determination of the actuator force via the motor energization of the electric engine of the level regulating system, additional direct-acting devices for force measurement are not required. In the simplest case, the device is designed as a level adjustment system; in a further developed embodiment, a feedback within the system is present, so that it is designed as a level regulating system.

If several actuators are present within the level adjustment system and/or regulating system, it is possible to conclude by summation of the individual regulating forces on the load condition of the motor vehicle. Regardless of the number of actuators that are used for level adjustment or level control, the force data determined by the system can be used, for example, to adjust settings on the rear axle of the motor vehicle to the trunk load. Furthermore, the data obtained via the system about the load state of the motor vehicle can be used to automatically adjust parameters of a driving dynamic vehicle control.

In addition to a motor phase current measurement, the detection of engine speed and/or direction of rotation, relative to the at least one electric engine of the actuator unit, may also be provided within the system. In addition to an adjustment speed of the level adjustment, the adjustment direction is thus detectable.

A further development of the system takes into account the fact that—depending on the design of the actuators—the frictional forces and frictional moments acting in the actuator typically depend on different environmental conditions, and ultimately are only partially known. It has been shown that despite deficiencies, which relate to information about the operating characteristics of the transmission of the actuator unit, meaningful and reliable data on actuator forces and thus the load state of the motor vehicle can be obtained by detecting and averaging forces over a full adjustment cycle, which includes an upward adjustment phase and a downward phase.

For this purpose, the calculation unit can be coupled to a database, which can also be an integral part of the control unit. The database is designed for storing data relating to the electric engine during at least one upward adjustment phase and at least one downward adjustment phase. Both in the upward adjustment and in the downward adjustment of the vehicle body, there is typically given a proportionality between the effective motor phase current IM, with which the electric engine of the actuator unit is powered, and the generated engine torque MM:

MM=CMIM,

where CM is an engine constant. At the output of the transmission of the actuator, by virtue of the transmission reduction i there results a force FAkt of

Fakt=i(MM−MR)=i(CMIM−MR),

where MR is the sum of the torque losses caused by friction occurring in the actuator unit. When the vehicle body is raised, the friction torque MR counteracts the engine torque MM generated by the electric engine. When lowering the vehicle body, however, a braking torque is reduced by the friction torque MR applied by the electric engine. If the transmission, which is used within the level control system for raising and lowering the vehicle body, is designed as a self-locking gear, so also driving torque is applied by the electric engine during the lowering process.

The magnitude of the friction torque MR, as well as the relation between the friction torque MR and the engine torque MM, is highly dependent on the type of transmission of the actuator unit. A transmission may be used in which the friction torque MR significantly depends on whether an upward or downward adjustment of the vehicle body takes place. Accordingly, MRa denotes the friction torque to be overcome in the upward adjustment and MRu the friction torque acting in the downward adjustment. This results in differing actuator forces during upward movement and/or downward movement of the vehicle body:

FAkt,a=i(CMIMa−MRa)

Fakt,u=i(CM IMU+MRU),

where IMa indicates the engine current for upward adjustment and IMu the motor current for downward adjustment. By a good approximation, it can be assumed that the friction torque MRa and Mm differ by a constant value:

MRU=MRA+ΔMR

This relationship may apply in cases where corresponding speed profiles are realized in the upward adjustment and in the downward adjustment by the system. The dependence of the differential friction torque ΔMR is determined experimentally if necessary. If an upward adjustment and a downward adjustment of the vehicle body is carried out while the loading state remains the same, it can furthermore be assumed with good approximation that the regulating force FAkt,a applicable for the upward adjustment corresponds to the regulating force FAkt,u applicable for the downward adjustment. Thus, the actuator force FAkt generated by the system can be expressed as follows:

FAkt=½(FAkt,a+FAkt,u)

If the FAkt forces FAkt,a and FAkt,u used for the upward or downward adjustment are used, the result is

FAkt=% i(CM(IMa+IMu)+ΔMR)

From this it be seen that the friction torque MR is not needed for the determination of the and thereby actuator force FAkt. Instead, the calculation unit, in addition to the parameters CM and ΔMR, which can be assumed to be constant, only processes the engine currents Ima and Imu, from which an average is formed over at least one adjustment cycle.

As a transmission of the actuator, a spindle drive may be used, including a spindle drive with pronounced asymmetrical friction property, as described, for example, in DE patent application 10 2016 207 615.9 (Filing date: May 3, 2016).

It is thus possible for the transmission to be inserted as well as displayed in this way, in that only a slight braking torque occurs when the vehicle body is raised, while when lowering the vehicle body a multiple braking torque occurs, which greatly reduces the braking torque to be generated additionally by the electric engine or even requires a drive torque during lowering. In the latter case, the drive of the actuator unit is designed as a one-sided, self-locking transmission. This means that a force introduced on the output side of the transmission in a first direction leads to an input-side movement, while an output-side introduction of a force in the opposite direction causes a blocking of the transmission.

The advantage of the disclosure may be applicable in any case that control electronics are used, which are typically present in an electromechanical level control system, to shut down in response to the load condition of the vehicle.

### BRIEF DESCRIPTION OF THE DRAWINGS

An embodiment of the disclosure will be explained in more detail with reference to a drawing. Shown herein:

FIG. 1 a level control system for a motor vehicle in a schematic representation,

FIG. 2 a flowchart of a method which can be carried out with the system according to FIG. 1.

### DETAILED DESCRIPTION

A level adjustment system, generally designated by the reference numeral 1, namely a level control system, is intended for installation in a motor vehicle, not shown, namely a passenger car or a utility vehicle. The level control system 1 may be constructed from a control unit 2 and an actuator unit 3. In a manner not shown, several actuator units 3 may be present within the motor vehicle, which are actuated by means of a single control unit 2 or more control units. Thus the level control system 1 is either the level control on a single axis or on several axles of the motor vehicle.

The actuator unit 3 comprises an electric engine 4 as well as a transmission 5 actuated by it, which may be constructed in one or more stages, and introduces force into a lifting element 7, which is coupled with suspension components, not shown. The electric engine 4 and the transmission 5 are found in the embodiment example in a common housing 6; the lifting element 7 can be moved out of the housing 6. By using the lifting element 7, an actuator force FAkt is transmitted to a chassis component in order to adjust the level of the vehicle body of the motor vehicle.

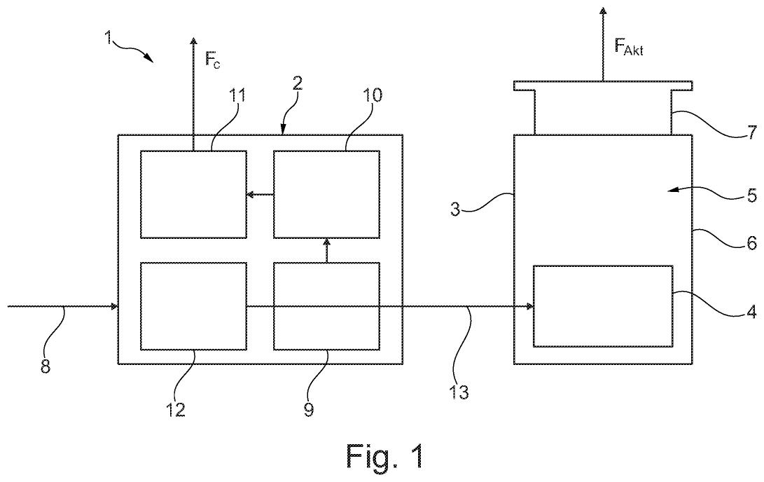

The control unit 2 is supplied via a connecting electric cable 8 with electrical energy. Components of the control unit 2 are a current sensor 9, a database 10, a calculation unit 11, as well as a power output 12. The components 9, 10, 11, 12 are not necessarily, as indicated in FIG. 1, within a common structural unit. Electric power is passed from the power output 12 to the electric engine 4 via an electric cable 13. The measurement of this current takes place with the aid of the current sensor 9. Measured current values are, as explained in more detail below, stored in the database 10 and fed to the calculation unit 11, which circulates a calculated force FC that at least approximately corresponds to the actuator force FAkt.

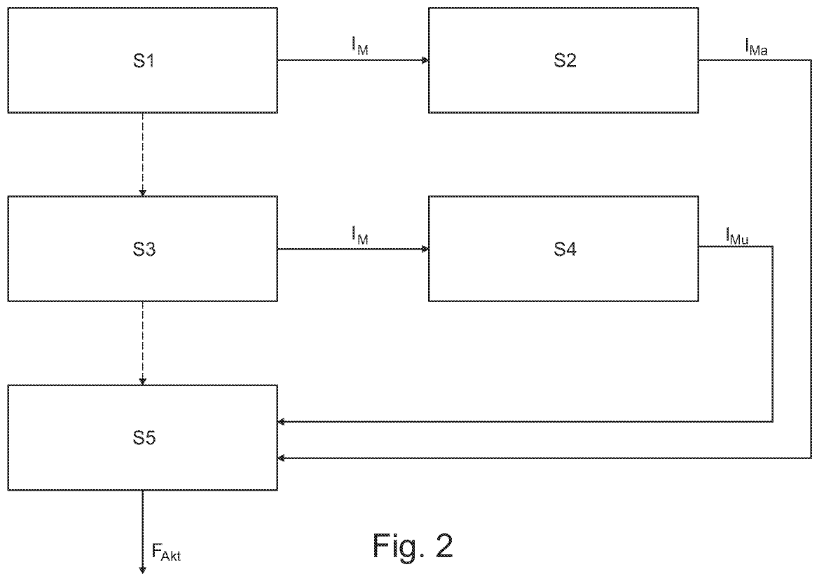

A method illustrated in FIG. 2, which can be carried out with the level control system 1 according to FIG. 1, begins with a first method step S1, which in the present case is assumed as an upward adjustment of the level control system 1—in short: as upward flow—. During this upward flow, the motor current IM is measured in the electric cable 13 by using the current sensor 9. In the second step S2, a storage and first averaging takes place, resulting in a mean upward current value IMa.

After the upward adjustment and any break in operation of the level control system 1, a downward adjustment, referred to briefly as downward flow of the level control system 1, takes place in step S3. Here, too, the motor current IM may be measured analogously to the first step S1. Similarly, storage and averaging takes place in an analogous manner, which results in this case in Step S4 an average engine current IMu relative to the lowering.

From the average motor current values IMa and IMu, the force FC is finally calculated in Step S5, which, if the model works realistically, corresponds to the actuator force FAkt. A direct force measurement on the actuator unit 3 or on other load components is thus not required for determining the load state of the motor vehicle.

### LIST OF REFERENCE NUMBERS

1 Level adjustment system, Level control system
2 Control unit
3 Actuator unit
4 Engine
5 Transmission
6 Housing
7 Lifting element
8 Connecting cable
9 Current sensor
10 Database
11 Calculation unit
12 Power unit
13 Cable
FAkt Actuator power, generated through the actuator unit
FC Calculated actuator force
IM Engine current
IMa Average engine current, upward flow
IMa Average engine current, downward flow
S1 . . . S5 Method steps

1. A level adjustment system for a motor vehicle, comprising:
an actuator unit which includes an electric engine and a transmission powered by the electric engine, wherein the actuator unit is configured to enable a level adjustment of the motor vehicle; and
a control unit that includes a calculation unit and a current sensor configured to detect the engine current fed into the electric engine to determine an actuator force generated by the actuator unit.

2. The level adjustment system of claim 1, wherein the calculation unit in the control unit is integrated.

3. The level adjustment system of claim 2, wherein the calculation unit is further configured to process information about engine speed and direction of rotation of the electric engine.

4. The level adjustment system of claim 3, wherein the calculation unit is coupled to a database that stores data relating to the electric engine during at least one upward adjustment phase and at least one downward adjustment phase of the actuator unit, wherein the calculation unit is adapted to process average engine currents relating to an adjustment cycle comprising an upward phase and a downward phase.

5. A The level adjustment system of claim 4, wherein the transmission has direction-dependent friction moments.

6. The level adjustment system of claim 5, wherein it is designed as a leveling system.

7. Method for operating a level adjustment system, of a motor vehicle that includes an electrical engine and a downstream transmission, comprising:
powering the electrical engine by a control unit;
detecting an engine current during a metrological adjustment;
storing the detected engine current; and
calculating an actuator force acting in the level adjustment system in response to the engine current.

8. The method of claim 7, wherein the engine currents during an adjustment cycle that includes an upward phase and a downward phase; is detected and averaged to calculate the actuator force.

9. The method of claim 8, wherein calculating the actuator force includes a non-zero difference between a reference to a first adjustment direction
friction torque and a second adjustment direction related friction torque of the transmission.

10. (canceled)

11. A level adjustment system of a vehicle, comprising:
an electric engine;
a transmission driven by the electric engine; and
a controller programmed to identify a motor current from the electric engine during an upward adjustment or downward adjustment of the vehicle, wherein the controller is further programmed to determine an actuator force generated by an actuator unit utilizing the motor current.

12. The level adjustment system of claim 11, wherein the controller is further programmed to measure the motor current at multiple instances during an upward adjustment to identify a mean upward current value in response to the upward adjustment to the level control system.

13. The level adjustment system of claim 11, the controller is further programmed to measure the motor current during a downward adjustment at multiple instances to identify an average engine current in response to the downward adjustment to the level control system.

14. The level adjustment system of claim 11, wherein the controller is further programmed to adjust settings on a rear axle of the vehicle in response to the actuator force.

15. The level adjustment system of claim 11, wherein the controller is further programmed to adjust parameters of a driving dynamic vehicle control.

16. The level adjustment system of claim 11, wherein the controller includes a current sensor.
